(19) United States
(12) Patent Application Publication
(10) Pub. No.: US 2012/0139797 A1
(43) Pub. Date: Jun. 7, 2012

(54) ANTENNA DEVICE

(75) Inventor: Junichi Fukuda, Tokyo (JP)

(73) Assignee: NEC CORPORATION, Tokyo (JP)

(21) Appl. No.: 13/390,522

(22) PCT Filed: Aug. 20, 2010
(86) PCT No.: PCT/JP2010/064082

§ 371 Date: Feb. 15, 2012

(30) Foreign Application Priority Data
Aug. 25, 2009 (JP) 2009-194240

(51) Int. Cl. H01Q 1/38

(52) U.S. Cl. 343/700 MS

(57) ABSTRACT

An antenna device includes a plurality of antenna elements, a feed circuit which feeds power to the plurality of antenna elements, a conductive chassis which accommodates the plurality of antenna elements and the feed circuit and which is provided with a plurality of opening portions as being opposed respectively to the plurality of antenna elements, and a sheet-shaped cover which covers the plurality of opening portions of the conductive chassis to seal the plurality of opening portions. In addition to covering the plurality of opening portions of the conductive chassis, the sheet-shaped cover may cover the entire conductive chassis. A patch antenna may be utilized as each of the plurality of antenna elements.

### TECHNICAL FIELD

The present invention relates to an antenna device, and in particular, relates to an antenna device which is used mainly at a base station.

### BACKGROUND ART

Normally, a base station antenna is installed at a high place. Transmitting and receiving of data is performed by the base station antenna and a land-based communication terminal or a mobile communication terminal through radio waves emitted from the antenna.

Such a base station antenna is required to form a beam pattern so that radio waves are emitted to a certain area in the ground direction. Accordingly, the base station antenna has a structure of an array antenna with antenna elements arranged in the vertical direction. The base station antenna having the above structure includes a feed circuit to feed power of a predetermined amplitude and a predetermined phase to each antenna element so that each antenna element can obtain the specific beam pattern.

In general, the beam pattern of the base station antenna is formed to have a beam width of about 6 degrees in the vertical plane and a beam width of 60 to 180 degrees in the horizontal plane. To obtain the beam width of about 6 degrees in the above-mentioned vertical plane and a desired gain, the number of elements to be utilized as the antenna elements is approximately on the order of 12 to 14 pieces. Further, the base station antenna adopts a reflection plate formed of a metal plate at a back side of the antenna elements to form the beam width in the horizontal direction.

Further, normally, the base station antenna has a port for a vertically-polarized wave or a horizontally-polarized wave, or alternatively, has two ports for two polarized waves including both of the horizontally-polarized wave and the vertically-polarized wave or two ports for two polarized waves of +45 degrees and −45 degrees.

Further, normally, the base station antenna is structured as being covered by a radome which is made of material such as fiber reinforced plastic (FRP) and polyvinyl chloride (PVC) as a structure capable of enduring against outdoor environment.

An example of an antenna having a structure of being covered with a radome is described in Patent literature 1 (PTL1). In a flat antenna described in PTL1, a sealed container is structured with a metal-made shield plate and a radome. In this regard, owing to such a sealed structure, air pressure difference occurs between the inside and outside of the flat antenna which is caused as a result of expansion and contraction of air within the flat antenna in accordance with temperature variation of the inside and outside of the flat antenna. The air pressure difference between the inside and outside of the flat antenna is applied evenly to the metal-made shield plate and the radome. Since the radome generally has smaller stiffness than the metal-made shield plate, the radome is deformed. Accordingly, in the flat antenna described in PTL1, round holes are formed to prevent deformation of the radome to be caused by air pressure variation and temperature variation at the inside and outside of the flat antenna.

### CITATION LIST

### Patent Literature

{PTL 1} Japanese Patent Application Laid-Open Publication No. 05-145317

### SUMMARY OF INVENTION

### Technical Problem

A base station antenna for outdoor installation utilized for the communication exemplified above has a structure of being covered with a radome which is normally made of material such as FRP and PVC to be endurable to outdoor environment. Here, to obtain a sealed structure, there is a tendency that an outer shape is enlarged and that weight is increased. For example, in the flat antenna described in PTL1 which is described above, it is possible to cope with air pressure variation and temperature variation by arranging the round holes. However, owing to the structure of being covered with the radome, problems of the enlarged outer shape and the increased weight cannot be solved.

In addition, a base station antenna has a structure to include a reflection plate made of metal material at a back side of antenna elements to obtain a predetermined beam width in the horizontal direction. Since the reflection plate requires certain area, there is a tendency that weight of the base station antenna is increased.

Since the above-mentioned base station antenna is normally installed at a high place of an outdoor steel tower or of a building, it is required to have strength against antenna weight and attaching strength to prevent rotation due to strong wind.

Further, the increased antenna weight is a factor to worsen operability of installation.

An exemplary object of the present invention is to provide a small and light antenna device with a relatively simple structure and a wireless communication device utilizing the same.

### Solution to Problem

An antenna device according to an exemplary aspect of the present invention, includes a plurality of antenna elements, a feed circuit which feeds power to the plurality of antenna elements, a conductive chassis which accommodates the plurality of antenna elements and the feed circuit and which is provided with a plurality of opening portions as being opposed to the plurality of antenna elements respectively, and a sheet-shaped cover which covers the plurality of opening portions of the conductive chassis to seal the plurality of opening portions.

### Advantageous Effects of Invention

According to the present invention, it is possible to obtain light and thin structure in an antenna device without requiring an antenna radome. Therefore, it is possible to provide an antenna device having a small and light structure.

### BRIEF DESCRIPTION OF DRAWINGS

FIG. 1 A perspective view illustrating an antenna device according to a first embodiment of the present invention.

FIG. 2 A sectional view illustrating an internal structure of the antenna device of FIG. 1.

FIG. 3 A perspective view illustrating an internal structure of the antenna device of FIG. 1.

FIG. 4 A perspective view illustrating a part of a printed circuit board and a sheet metal chassis.

FIG. 5 An enlarged partial view of the printed circuit board of FIG. 4.

FIG. 6 A view illustrating an antenna device according to a second embodiment of the present invention.

### DESCRIPTION OF EMBODIMENTS

First, outline of an exemplary embodiment of the present invention will be described. An antenna device according to the exemplary embodiment of the present invention has a structure that a plurality of array antenna elements and a feed circuit to feed power of a predetermined amplitude and a predetermined phase to the antenna elements are accommodated at the inside of a conductive chassis. The conductive chassis is provided with a plurality of opening portions as being opposed respectively to the plurality of antenna elements. Then, the plurality of opening portions are sealed with a sheet-shaped cover or the entire conductive chassis is sealed with the sheet-shaped cover. The conductive chassis and the sheet-shaped cover function as a reflection plate and a radome of the antenna device. For example, a patch antenna is utilized as the antenna elements. With the above, the antenna device of the present embodiment can have a small structure, and in particular, can have a thin structure and does not require an antenna radome. Accordingly, it is possible to obtain an antenna device having a small and light structure.

Next, the exemplary embodiment of the present invention will be described in detail with reference to the drawings.

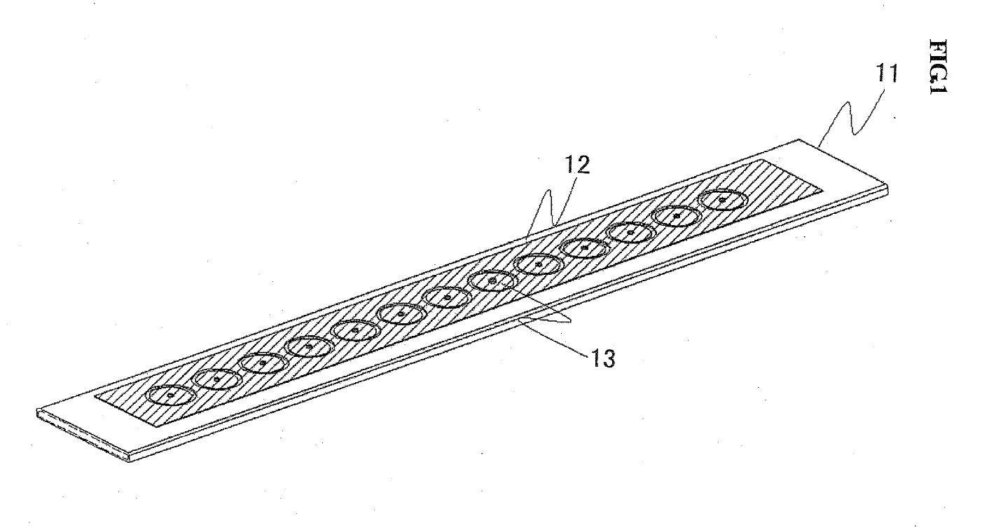

FIG. 1 is a perspective view of an antenna device as an embodiment of the present invention.

As illustrated in FIG. 1, the antenna device of the present embodiment includes a sheet metal chassis 11, a sheet-shaped cover 12, a plurality of antenna elements 13 and a feed circuit. In this example, 13 pieces of the antenna elements are arranged. However, the number thereof is not limited to the above. Here, as already described above, in a case of the antenna device used as a base station antenna, the number of antenna elements to be utilized is on the order of 12 to 14 pieces. The sheet-shaped cover 12 can be formed of a resin tape such as polyvinyl chloride (PVC) tape.

The antenna elements 13 and the feed circuit are accommodated in a rectangle-shaped sheet metal chassis 11 being a conductive chassis. In FIG. 1, the feed circuit is not illustrated for omission. Details of the feed circuit will be described later. The sheet metal chassis 11 is provided with a plurality of opening portions as being opposed respectively to the plurality of antenna elements 13. In short, portions above the upper faces of the plurality of antenna elements 13 are opened. Further, the antenna device of the present embodiment has a structure that the plurality of opening portions of the sheet metal chassis 11 are covered with the sheet-shaped cover 12 to seal the plurality of opening portions. In the present embodiment, the sheet metal chassis 11 formed of a metal plate is utilized as the conductive chassis. However, it is also possible to obtain the conductive chassis by forming a conductive layer on an insulating plate member such as plastic plate member or utilizing conductive plastic member. Fundamentally, the sheet metal chassis 11 is not opened at both ends in the longitudinal direction. However, it is possible that one end or both ends of the sheet metal chassis 11 are opened as needed basis. Here, although the sheet metal chassis is shaped rectangular to be advantageous for downsizing and lightening, it is not necessarily required to be rectangular.

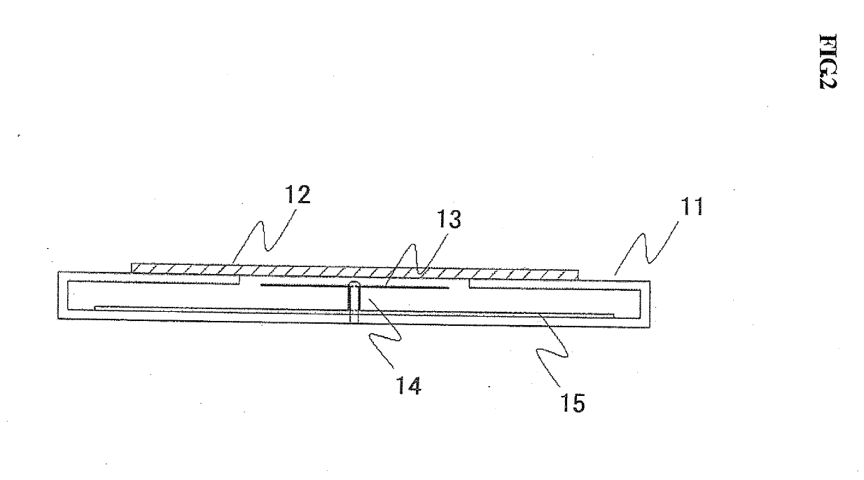

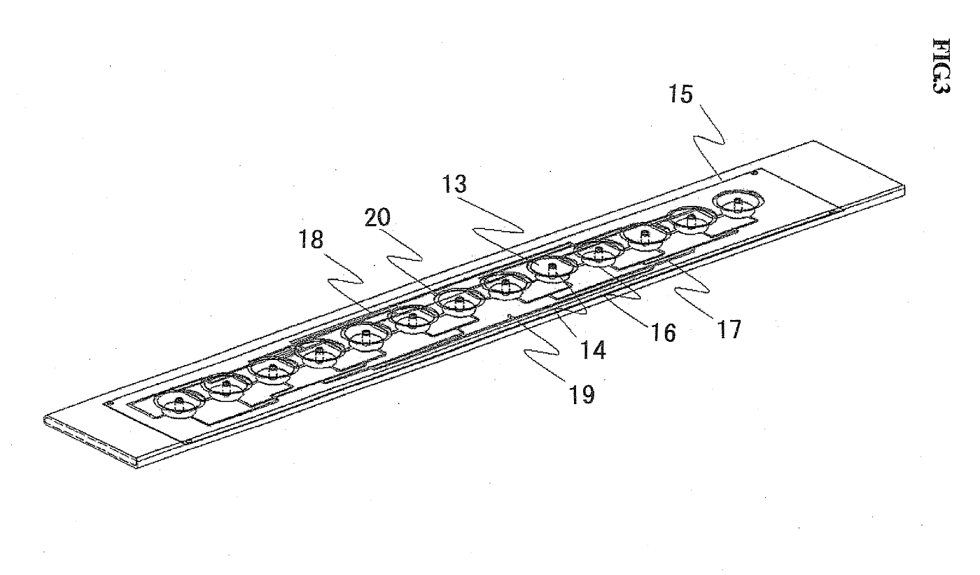

FIG. 2 is a sectional view illustrating an internal structure of the antenna device of FIG. 1. FIG. 3 is a perspective view illustrating an internal structure of the antenna device of FIG. 1. In FIG. 3, a printed circuit board 15, feed circuits 17, 18 and antenna elements 16 at the inside of the antenna device are illustrated by solid lines and the sheet-shaped cover 12 is not illustrated.

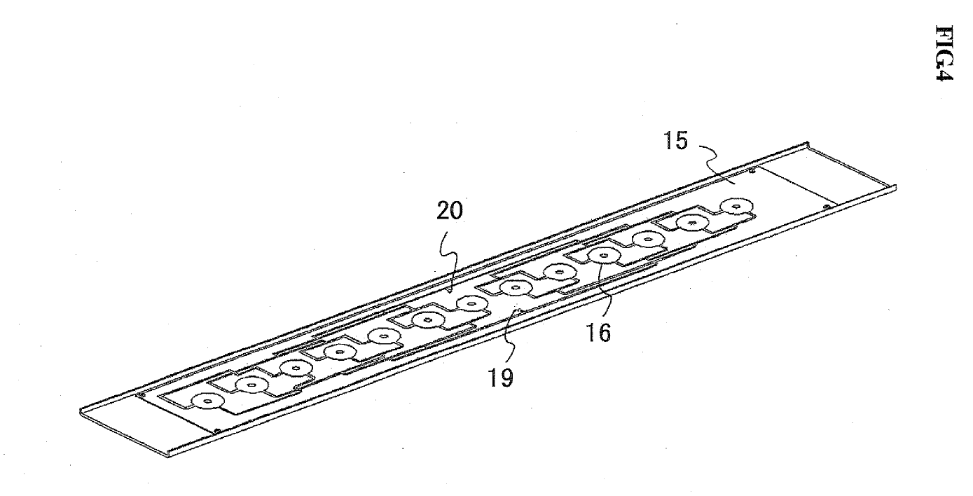

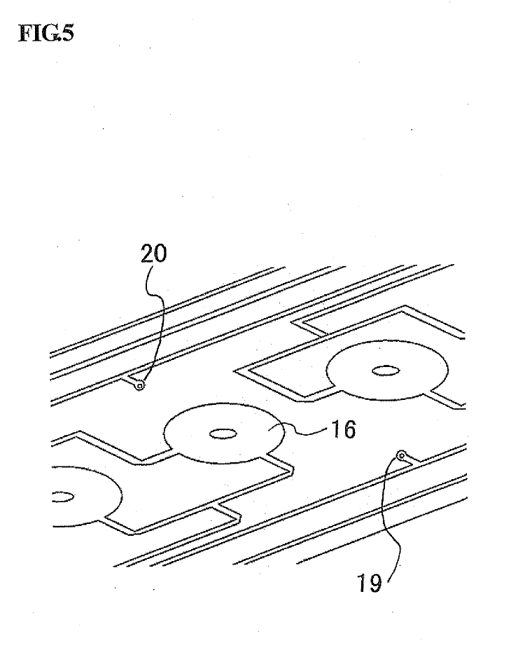

FIG. 4 is a perspective view illustrating a part of the printed circuit board and the sheet metal chassis. FIG. 5 is an enlarged partial view of the printed circuit board of FIG. 4.

Referring to FIGS. 2 to 5, the antenna device of the present embodiment includes the printed circuit board 15 in the rectangular sheet metal chassis 11. The feed circuits 17, 18 and the antenna elements 16 which will be described later are provided on the printed circuit board 15. The antenna elements 13 are connected to the antenna elements 16 via center poles 14 being conductive poles. Further, as described above, the sheet metal chassis 11 has the structure that the upper side against the antenna elements 13 is opened and the plurality of opening portions of the sheet metal chassis 11 are covered with the sheet-shaped cover 12.

As illustrated in FIGS. 3 to 5, the printed circuit board 15 has feed circuits (i.e., the feed circuit 17 and the feed circuit 18). Power is fed to each feed circuit from a feed position 19 or a feed position 20.

Operation of the antenna device of the present embodiment described with reference to FIGS. 1 to 5 will be described in the following.

In the antenna device of the present embodiment, input power is fed from the feed position 19 on the feed circuit 17 and the feed position 20 on the feed circuit 18 formed on the printed-circuit board 15. The fed power is fed respectively to the antenna elements 13 and the antenna elements 16 formed on the printed circuit board 15 as being distributed into predetermined power and amplitude by the feed circuit 17 and the feed circuit 18. A coaxial cable is connected respectively to the feed position 19 and the feed position 20 and power is fed via the coaxial cables. It is also possible to attach a connecter to the printed circuit board 15 and to feed power via the connecter. Drawing of the coaxial cable can be performed by forming an opening portion on the degree being capable of drawing therethrough at the sheet metal chassis 11.

The antenna elements 16 and the antenna elements 13 are connected via the center poles 14, so that a broad band of the antenna can be obtained. Here, it is also possible to dispose only the antenna elements 16 without disposing the antenna elements 13 and the center poles 14. In such a case, the sheet metal chassis 11 is provided with a plurality of opening portions as being opposed respectively to the plurality of antenna elements 16.

The plurality of antenna elements 16 and the plurality of antenna elements 13 are arranged at predetermined intervals and a predetermined beam pattern in the vertical direction is formed with the amplitude and phase distributed by the feed circuit 17 and the feed circuit 18.

The beam width in the horizontal direction is determined by the width of the sheet metal chassis 11 and characteristics of a patch antenna which is constituted with the antenna elements 13 and the antenna elements 16. For example, the beam width is set to about 65 degrees.

Here, the feed circuit 17 feeds power to the antenna elements 16 in the horizontal (i.e., lateral) direction, so that the present antenna device emits a horizontally-polarized wave. Meanwhile, the feed circuit 18 performs feeding power in the horizontal (i.e., longitudinal) direction of the antenna elements 6, so that the present antenna device emits a vertically-polarized wave. The feed circuit 17 corresponds to a second feed circuit and the feed circuit 18 corresponds to a first feed circuit.

The sheet metal chassis 11 is provided with the opening portions for emitting a radio wave from the present antenna device. The sheet-shaped cover 12 covers the opening portions of the sheet metal chassis 11 to seal the antenna inside of the present antenna device.

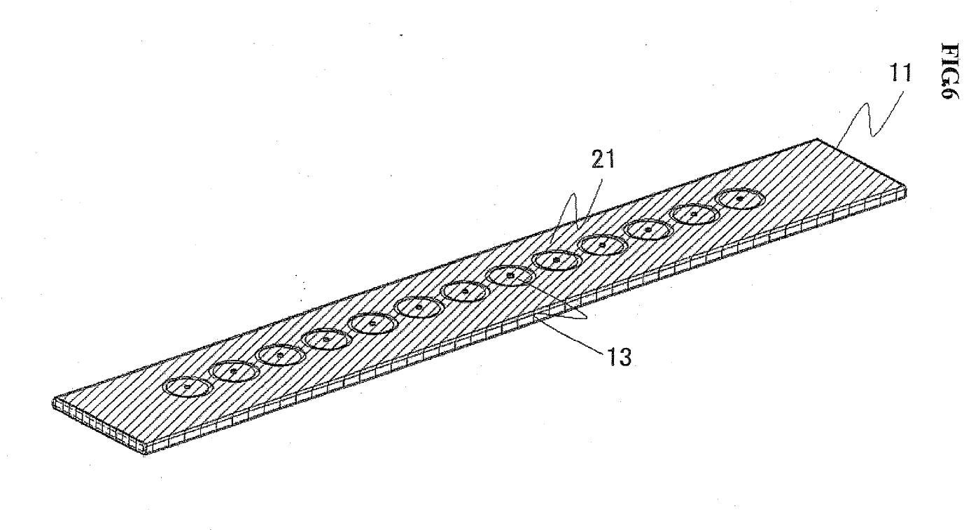

Next, another embodiment of the present invention will be described with reference to FIG. 6.

In the above-mentioned antenna device of FIGS. 1 to 5, the sheet-shaped cover 12 is arranged to cover the opening portions of the sheet metal chassis 11. An antenna device illustrated in FIG. 6 has a structure that the entire sheet metal chassis 11 is covered with a cover 21. In the antenna device illustrated in FIG. 6 having higher sealing ability compared to the above-mentioned antenna device of FIGS. 1 to 5, a heat-shrinkable tube formed of polyolefin resin, for example, may be utilized as the cover 21.

In the above-mentioned embodiment, description is performed on the case that a round-shaped antenna element is utilized as the antenna elements 13 and the antenna elements 16. However, this is simply an example. It is also possible to utilize a rectangular-shaped antenna element as the antenna elements 13 and the antenna elements 16.

Further, in the antenna device of the present embodiment, description is performed on an example of concurrently utilizing a vertically-polarized wave and a horizontally-polarized wave. Here, this is just an example as well. It is also possible to utilize as an antenna device utilizing only either a vertically-polarized wave or a horizontally-polarized wave by utilizing only either the feed circuit 17 or the feed circuit 18. It is also possible to arrange only either the feed circuit 17 or the feed circuit 18 on the printed circuit board 15. Further, it is also possible to obtain an antenna having polarized waves of +45 degrees and −45 degrees by modifying feed positions of the antenna elements 16.

As described above, the antenna device of the present embodiment has the structure that the plurality of antenna elements and the feed circuits for feeding the predetermined amplitude and phase to the antenna elements are accommodated at the inside of the sheet metal chassis and the opening portions are formed at the sheet metal chassis above the antenna elements. Then, with the structure that the opening portions are covered with the sheet-shaped cover or the structure that the entire sheet metal chassis is covered with the sheet-shaped cover, the sheet metal chassis and the sheet-shaped cover are structured to have functions of a reflection plate and radome of the antenna device. Further, by utilizing the patch antenna as the antenna elements, the present antenna is structured to be advantageous for downsizing, and in particular, for thinning. Accordingly, since an antenna redome which is generally imperative becomes unnecessary, an antenna device having a small and light structure can be actualized. Here, as the sheet-shaped cover of the antenna device of FIGS. 1 to 5, a heat-shrinkable tube may be utilized for covering a periphery of a part of the sheet metal chassis 11 so as to cover the opening portions of the sheet metal chassis 11. Further, as the sheet-shaped cover of the antenna device of FIG. 6, a resin tape may be utilized for covering the entire sheet metal chassis 11.

Further, the above-mentioned embodiments are preferable embodiments of the present invention. Here, the scope of the present invention is not limited only to the above embodiments. The present invention can be embodied with various modifications without departing from the scope of the present invention. Accordingly, the above-mentioned embodiments are simply examples and limited construe should be avoided. The scope of the present invention is defined by the scope of the claims without being limited by description of the application and abstract. Further, changes and modifications belonging to a scope equivalent to the scope of the claims are within the scope of the present invention. Furthermore, not limited to a specific communication method or a device, the present invention can be applied to various communication methods and devices.

This application claims the benefit of Japanese Patent Application No. 2009-194240 filed Aug. 25, 2009. The entire description disclosed in Japanese Patent Application No. 2009-194240 is included in this application.

### DESCRIPTION OF REFERENCE NUMERALS

11 Sheet metal chassis
12 Sheet-shaped cover
13 Antenna element
14 Center pole
15 Printed circuit board
16 Antenna element
17 Feed circuit
18 Feed circuit
19 Feed position
20 Feed position
21 Cover

1. An antenna device, comprising:
a plurality of antenna elements;
a feed circuit which feeds power to the plurality of antenna elements;
a conductive chassis which accommodates the plurality of antenna elements and the feed circuit and which is provided with a plurality of opening portions as being opposed to the plurality of antenna elements respectively; and
a sheet-shaped cover which covers the plurality of opening portions of the conductive chassis to seal the plurality of opening portions.

2. The antenna device according to claim 1,
wherein the sheet-shaped cover covers the entire conductive chassis.

3. The antenna device according to claim 1,
wherein each of the plurality of antenna elements is a patch antenna.

4. The antenna device according to claim 1,
wherein the feed circuit includes at least either a first feed circuit for a first polarized wave or a second feed circuit for a second polarized wave.

5. The antenna device according to claim 4,
wherein the first polarized wave is a vertically-polarized wave and the second polarized wave is a horizontally-polarized wave.

6. The antenna device according to claim 1,
wherein the feed circuit is formed on a circuit board; and
the plurality of antenna elements are connected to the circuit board via conductive poles.

7. The antenna device according to claim 1,
wherein the plurality of antenna elements include a plurality of first antenna elements and a plurality of second antenna elements;
the feed circuit and the plurality of second antenna elements are formed on a circuit board and the plurality of first antenna elements are arranged on the plurality of second antenna elements;
the plurality of first antenna elements are connected to the plurality of second antenna elements via conductive poles; and
the plurality of opening portions are arranged as being opposed to the plurality of first antenna elements respectively.

8. The antenna device according to claim 1,
wherein the sheet-shaped cover is a resin tape or a heat-shrinkable tube.

9. The antenna device according to claim 1,
wherein material of the sheet-shaped cover is polyvinyl chloride or polyolefin.

10. The antenna device according to claim 1,
wherein the conductive chassis is formed of any of a metal plate, conductive plastic plate, and an insulating plate of which surface has a conductive layer thereon.

11. The antenna device according to claim 2,
wherein each of the plurality of antenna elements is a patch antenna.

12. The antenna device according to claim 2,
wherein the feed circuit includes at least either a first feed circuit for a first polarized wave or a second feed circuit for a second polarized wave.

13. The antenna device according to claim 2,
wherein the feed circuit is formed on a circuit board; and
the plurality of antenna elements are connected to the circuit board via conductive poles.

14. The antenna device according to claim 2,
wherein the plurality of antenna elements include a plurality of first antenna elements and a plurality of second antenna elements;
the feed circuit and the plurality of second antenna elements are formed on a circuit board and the plurality of first antenna elements are arranged on the plurality of second antenna elements;
the plurality of first antenna elements are connected to the plurality of second antenna elements via conductive poles; and
the plurality of opening portions are arranged as being opposed to the plurality of first antenna elements respectively.

15. The antenna device according to claim 2,
wherein the conductive chassis is formed of any of a metal plate, conductive plastic plate, and an insulating plate of which surface has a conductive layer thereon.
